(19) United States
(12) Patent Application Publication
(10) Pub. No.: US 2003/0063839 A1
(43) Pub. Date: Apr. 3, 2003

(54) Fault isolation of individual switch modules using robust switch architecture

(76) Inventors: Scott Kaminski, Highlands, NJ (US); Mohammad Laham, Basking Ridge, NJ (US); Boris Stefanov, Gillette, NJ (US); Kevin Beach, Old Bridge, NJ (US)

Correspondence Address: KAPLAN & GILMAN , L.L.P., 900NROUTE 9 NORTH, WOODBRIDGE, NJ, 07095, US

(21) Appl. No.: 10/040,893

(22) Filed: Jan. 2, 2002

Related U.S. Application Data
(60) Provisional application No. 60/325,441, filed on May 11, 2001.

(51) Int. Cl. G02B 6/35

(52) U.S. Cl. 385/17; 385/16

(57) ABSTRACT

A robust nonblocking switch architecture is presented, in the first and final stages made of switch modules which have extra, unallocated, input and output ports beyond those necessary to render the switch architecture nonblocking. Each middle stage has an extra switch module, affording it spare unallocated ports as well. A method of isolating a fault is also presented, given the robust switching architecture. Operating on each stage one at a time, the switching architecture is reconnected so as to bypass either the input, the output, or both the input and the output ports of the switch module in such stage impacted in the faulted signal path. Such method allows the isolation of the faulty switch module, and can be done automatically, with either external apparatus, or integrated fault isolation equipment.

### CROSS REFERENCE TO RELATED APPLICATIONS

This application claims the benefit of U.S. Provisional Patent Application No. 60/325,441 filed on May 11, 2001.

### TECHNICAL FIELD

This invention relates to optical data networks, and more particularly relates to the utilization of a novel switch architecture to facilitate fault isolation to a specific switch module.

### BACKGROUND OF THE INVENTION

Numerous modern telecommunication systems applications require deploying large non-blocking cross-connects that allow connections between a number of idle input ports and a corresponding number of idle output ports. The demand for high port count cross-connects in the telecommunications applications exceeds the current ability to build the cross-connects in a single monolithic unit, especially in all-optical cross-connects. Traditionally, Clos and other architectures have been commonly used to solve this problem by connecting several smaller cross-connects to form a larger one.

In the Clos architecture, switches with a relatively small port count can be connected in multistage architectures and used as building blocks to achieve cross-connects with a much higher port count. The Clos architecture can thus be used to form a non-blocking cross-connect. It can be used in three, five, or even seven-stage architectures. Thus, a five-stage architecture uses a threestage architecture as a middle stage, etc. The problem with such a design is that the cumulative nature of the architecture exaggerates some of the undesirable optical characteristics of the switch modules (e.g. insertion loss) as the number of stages increase. For this reason, building a crossconnect using a five or seven-stage architecture generally results in producing an unacceptable insertion loss in the switching fabric. Thus, the most commonly used architecture is that of the three-stage switching architecture.

The Standard Clos Architecture

According to the Clos architecture (references to the Clos architecture herein refer to that described in Clos, Charles, A Study of Nonblocking Switching Networks, The Bell System Technical Journal, March 1953, p. 406), a N×N non-blocking cross-connect can be built using smaller switch modules (building blocks) in a multi-stage design. The resulting N×N cross-connect has N input ports and N output ports. For a three-stage design, the switches are partitioned into an input stage, a middle stage, and an output stage. In general switches can be blocking or nonblocking. A nonblocking switch is one that is capable of realizing every interconnection pattern between the inputs and the outputs. I.e., any input port can be switched to any output port by the switch. Modern optical networks, inasmuch as they are configured to dynamically reprovision as well as reroute traffic in response to network conditions, require nonblocking switches.

Thus, in a three-stage switching fabric, the number of switch modules in the middle stage needs to be chosen such that enough ports are provided to avoid blocking in the worst-case scenario. This is accomplished as follows. For illustration purposes, the switch modules used in the first-stage of a three stage cross connect will be considered to have n×m size, where n is the number of inputs to the switch module and m is the number of outputs. (In general a switch is listed using the following convention: “A×B”, where A is the number of input ports and B is the number of output ports to the switch or switch module). In general m>n. In the third-stage, therefore, the switch modules need to have a minimum m×n size. In the middle stage, the switching modules are said to have size r×r, where r>m. Given the above-described definitions, a nonblocking N×N architecture is achieved if the following conditions are satisfied:

(i) m>2n−1

(ii) r(n×m) switch modules are used in the input stage

(iii) r(m×n) switch modules are used in the output stage;

(iv) m (r×r) switch modules are used in the middle stage; and

(v) n=N/r.

Where N, n, m and r above are all positive integers.

Note that condition (v) implies that r=N/n. For example, a non-blocking cross connect of 32×32 size (N=32) can be constructed using switch modules of the following port sizes: n=4, m=7, r=8. That is, using eight 4×7 first-stage switch modules, eight 7×4 third-stage switch modules, and seven middle stage 8×8 switch modules. Table I below shows the minimum values of n, m and r required to construct a non-blocking cross connect of selected N×N sizes (where N=32, 128, 512) as required by the Clos architecture.

TABLE I
CLOS ARCHITECTURE REQUIREMENTS

| | Required Clos Specifications | | |
|---|---|---|---|
| Port Size | n | m | r |
| 32 × 32 | 4 | 7 | 8 |
| 128 × 128 | 8 | 15 | 16 |
| 512 × 512 | 16 | 31 | 32 |

### Table I: Clos Architecture Requirements

As can be determined from the above discussion, the switching modules in the input stage have nearly double the number of outputs for each input. This is evident from the above equations (i) through (v), as the outputs of the input stage (i.e., the first stage) are r*m. Since the requirement is m≧2n−1 in the minimum case m=2n−1. As well, n=N/r. Thus, r*m=r*(2N/r−1), which reduces to 2N−r. This latter result is equal to 2N−N/n, or N(2−1/n). Thus, using the minimum allowed outputs from the first stage of N(2−1/n), the outputs are nearly doubled, approaching full doubling as N increases. This doubling greatly expands the available data pathways from the input ports to the middle stage, which allows the non-blocking property. These multiple pathways are cross-connected in the middle stage, and collapsed once again in the output stage into the N output ports.

While the standard Clos architecture is in fact a nonblocking one, it does not afford any possibilities for fault isolation. As well, in a typical Clos switch architecture, the beginning, final, and middle switching stages each use a different switch module, allowing no intercompatibility, and thus the stocking of multiple, and often specialty, parts.

What is needed is a switching architecture that will not only support nonblocking switching, but that will also allow for fault isolation at the switch module level.

What is further needed is a switching architecture that utilizes an identical and commonly available switching module throughout, within and across each stage. Thus the part count and maintenance of the switching architecture are simplified.

### SUMMARY OF THE INVENTION

A robust nonblocking switch architecture is presented, in the first and final stages comprised of switch modules which have extra, unallocated, input and output ports beyond those necessary to render the switch architecture nonblocking. Each middle stage has an extra switch module, affording it spare unallocated ports as well.

A method of isolating a fault is also presented, given the robust switching architecture. Operating on each stage one at a time, the switching architecture is reconnected so as to bypass either the input, the output or both the input and the output ports of the switch module in that stage which is impacted in the faulted signal path. Such method allows the isolation of the faulty switch module.

### BRIEF DESCRIPTION OF THE DRAWINGS

FIG. 1 depicts an exemplary three stage nonblocking switching architecture;

FIG. 2 depicts an exemplary switch module according to the present invention, and identifies the allocated and spare ports therein;

FIG. 3 depicts the fault isolation equipment setup according to the present invention;

FIG. 4 depicts an example standard transmission path through the switch architecture; and

FIGS. 5-8 depict the various setups utilized in fault isolation according to the method of the present invention.

Before one or more embodiments of the invention are explained in detail, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as in any way limiting.

### DETAILED DESCRIPTION OF THE PREFERRED EMBODIMENT

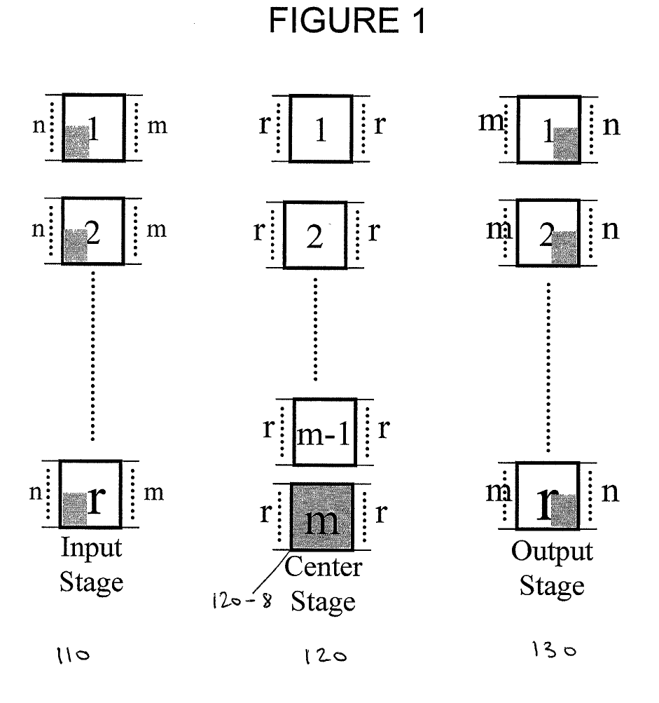

FIG. 1 depicts the standard Clos architecture. It satisfies the minimum requirements for being nonblocking, as discussed above. As further discussed above, its structure does not facilitate fault isolation at the individual switch module level. For the example discussed above for a three stage 32×32 nonblocking switch, N=32, n=4, m=7, and r=8; thus the first stage 110 has 8 4×7 switch modules, the middle stage 120 has 7 8×8 switch modules, and the third stage 130 has 8 7×4 switch modules.

Novel Switch Module and Architecture

The present invention solves the above described problems of the prior art by augmenting the standard Clos architecture. In a preferred embodiment of the novel design, m×m switch modules are used in the first and third stages rather than n×m and m×n modules, respectively (where m=2n). Thus only one switch module is needed to construct the switching architecture. Furthermore, the number of switch modules in the middle-stage is set to be m=2n rather than m≧2n−1 (which generally is implemented as m=2n−1, as depicted in FIG. 1). Consequently, an extra switch module is used in the middle stage and extra input and output ports become available in the first and third stages.

Table II below compares the novel switch module parameters according to the present invention with the conventional Clos parameters. As can be seen therefrom, in the switch architecture according to the present invention m=r.

TABLE II
CLOS ARCHITUCRURE REQUIREMENTS COMPARED
WITH THE ROBUST ARCHITECTURE OF THE
PRESENT INVENTION

| | Standard Clos | | | Present Invention | | |
|---|---|---|---|---|---|---|
| Port Size | n | m | r | n | m | r |
| 32 × 32 | 4 | 7 | 8 | 4 | 8 | 8 |
| 128 × 128 | 8 | 15 | 16 | 8 | 16 | 16 |
| 512 × 512 | 16 | 31 | 32 | 16 | 32 | 32 |
| N × N | N/r | 2n − 1 | r | N/r | 2n | 2n |

In the preferred embodiment, all switch modules in the architecture are thus identical, regardless of which stage they are utilized in. For a 32×32 switch each module is 8×8. In each stage r=N/n m×m modules, or 8 8×8 modules are used. This allows for N unallocated ports on each of the input and output sides of the switch, and m middle stage unallocated ports (available on the extra middle stage switch modules gained by the augmentation of m=2n−1 to m=2n).

The single switch module of the preferred embodiment allows manufacturing and maintenance efficiencies. However, if symmetry is not desirable in a particular design context, any enhanced switch module which augments the nonblocking minimum requirements with at least one unallocated input port and one unallocated output port is sufficient for each of the first and final stages. The middle stage or stages would still require at least one extra r×r module, all of whose ports, both input and output, are unallocated.

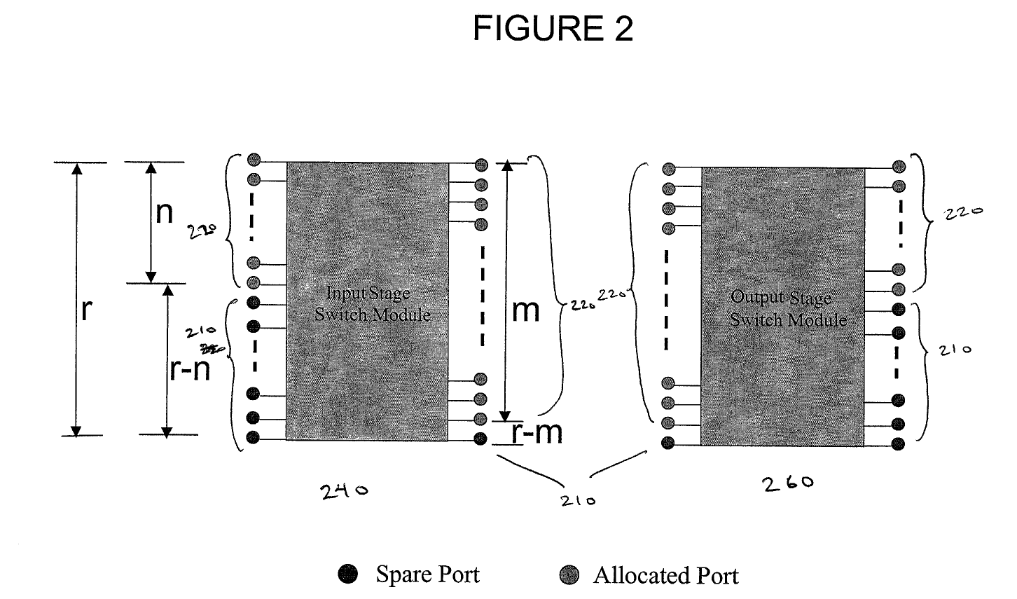

FIG. 2 depicts exemplary first and final stage switch modules according to the preferred embodiment of the present invention. The example switch module depicted is a more robust version of the conventional switch module for a 32×32 switch. The extra, or spare, ports 210 due to the robust design are depicted as light circles, whereas the allocated ports 220, identical with those in the standard Clos architecture, are shaded as dark. It is clear from FIG. 2 that the allocated ports satisfy the minimum Clos requirements, and thus considering only the allocated ports 220, the switch modules are n×m in the first stage 240, and m×n in the final stage 260. The spare ports are thus r−n input ports and r-m output ports for the first stage 240, and the mirror image, or r−m input ports and r−n output ports in the final stage 260. While FIG. 2 does not depict the middle stage according to the present invention, FIG. 1 does, if the shaded switch module 120-8 is included.

While having the spare ports does not increase the total port count for the resulting cross-connect, it provides spare ports for other usages.

As is implicit in its description, the augmented design still satisfies the Clos requirement for constructing a non-blocking switch, and is thus nonblocking. The robust switch module of the present invention also yields the following benefits: (i) additional input and output ports are available to be used as spare ports; (ii) an even (and similar) number of switch modules in each of the three stages simplifies the physical design of the system and the circuit packs, thus simplifying maintenance and part counts; and (iii) the design utilizes commonly available switch modules, which tend to have equal number of inputs and outputs, thus reducing cost.

Fault Isolation Procedure:

Given the robust switch module design, what will be next described is a novel method for isolating the fault within a three (or more) stage switch to a specific switch module connection therein. In the absence of this method there is no unique way for identifying the specific switch module responsible for a fault in a cross-connect end-to-end input/output path selection. The importance of identifying the switch module specifically is necessary in order to replace the impacted module with minimum or no impact on the operation of the remaining switch modules in the switch fabric.

A fault can be due to the failure of a single mirror, collimator, or optical connector within an individual switch module. Additionally, the fault can be due to a faulty switch module (and/or cable) in either the first, middle or third stages. Only in rare cases, where all ports within a particular switch module fail, would a conventional system be able to isolate the fault to that switch module. Using the robust switch module design presented herein, it is a simple matter to isolate the fault through the use of the extra unallocated input and output ports. The proposed method is non-intrusive and it does not impact data transmission on the remaining cross-connection path selections (since the architecture remains non-blocking even when the extra ports are used).

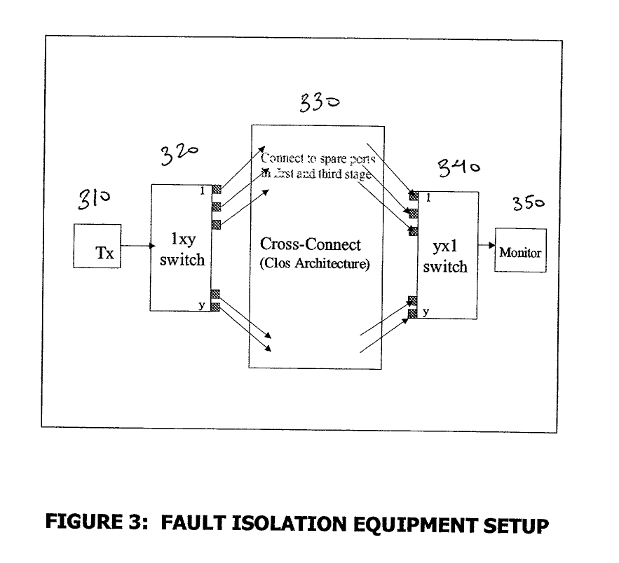

With reference to FIG. 3, the fault isolation method of the present invention is best implemented by using a 1×y external switch 320 that is connected to one of the extra input ports in each of the switch modules in the first-stage. The value of y can be chosen to accommodate the size of the resulting cross-connect. The maximum value of y is equal to r (the number of switch modules in the first-stage, which is equal to m in the robust switch module described above). If r is too large and 1×r switches are not available, several 1×y switches can alternatively be used. A similar switch that is configured as a y×1 switch 340 is used to connect one of the extra output ports from each of the third-stage (or final stage, if there are more than three stages) modules. A light source 310 is connected to the input side of the 1×y switch and a power monitor 350 is connected to the output side of the y×1 switch. Alternatively, a y×1 splitter can be utilized. This setup can be integrated into the existing telecommunication system architecture or can be used as a standalone setup for maintenance and diagnosis purposes

In order to isolate a fault condition for a particular end-to-end cross-connect path selection to a single switch module the following steps are to be followed:

1. Initially, the faulty end-to-end path selection through the cross-connect is detected by the communication system via a Loss of Power (LOP) detection, a detection which is commonly supported in conventional communications networks.

2. The communication system will determine the input port and output ports in each of the multi stage switch modules that are associated with the faulty end-to-end cross-connect path selection. This information is commonly available as part of the provisioned data.

3. From the port numbers, the three (or more) impacted switch modules (first-stage switch module, middle-stage switch module(s) and final-stage switch module) can be determined.

4. One or all of the tests described below are performed, until the fault is isolated to a specific switch module and/or cable combination.

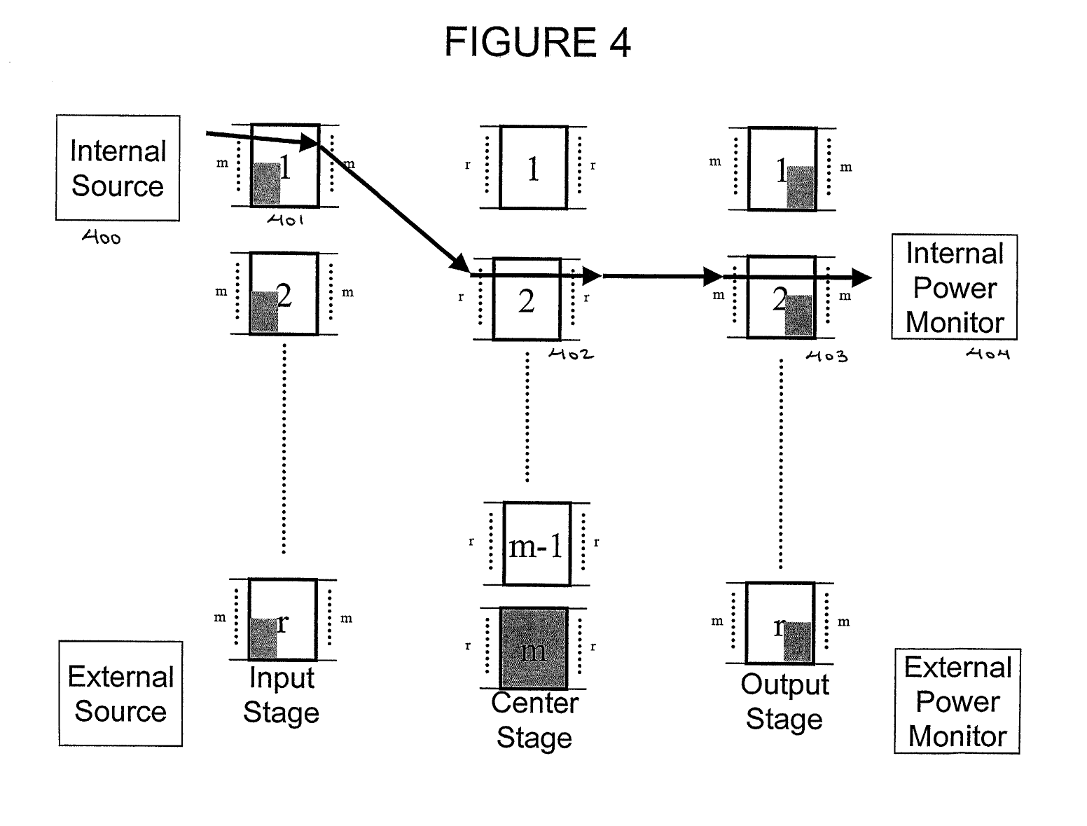

The fault isolation test procedure will next be described with reference to FIGS. 4-7, which have identical elements, and different switch connections.

FIG. 4, a larger version of FIG. 1, depicts the original transmission path through an exemplary three stage switching architecture according to the present invention. In FIG. 4, m=r=(2n−1), as above, and there are m=(2n−1) center stage switch modules. The data signal originates at internal source 400, passes through the input stage switch module 401, the middle stage switch module 402, and the final stage switch module 403, and ultimately to the internal power monitor 404. As described above, in the event of a LOP signal, the particular switch modules 401, 402 and 403, and their respective ports comprising the data path are known as part of the provisioned data.

In the event of the LOP, it remains to pinpoint which module is faulty. Each of the following Tests determines, utilizing the spare input and output ports of the robust switch module of the present invention, the original transmission path switch module at one of the three (or more) stages of the switching architecture. This allows isolation of the stage of, and thus, the faulty module, and its replacement or other remedial measure.

Test No. 1:

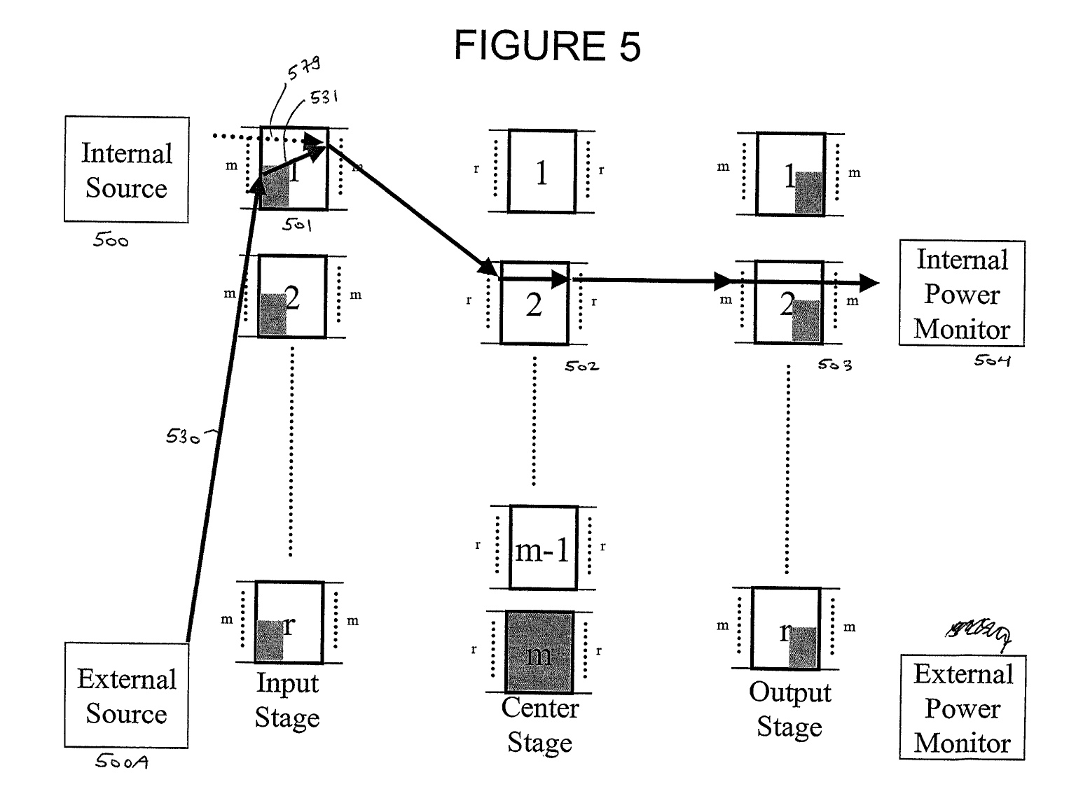

This test, depicted in FIG. 5, determines if the fault is due to the path selection in the first-stage switch. The input/output cross connection in the first-stage switch module is changed such that the output port is kept the same but the input port is switched to the extra input port that is connected to the 1×y switch (shown schematically as the External Source 500A). This is effected by routing the test signal through the impacted first stage switch module 501 via path 531 as opposed to path 579. Thus, Setup #1 differs from the original setup in the selection of the switching positions in the first-stage switch module only. Using the 1×y switch, or alternatively a splitter, a light source is injected (with input power equivalent to the nominal power input of the cross-connect) into the extra input port associated with the first-stage faulty path selection. The data path is now along segment 530, from the light source to the first stage switch module 501, and segment 531, from a spare input port in module 501 to the same output port as in the original configuration. The LOP condition (as determined by the internal system monitors) is observed to see if the condition abates. If so, the first-stage switch path selection is the cause of the fault.

Test No. 2:

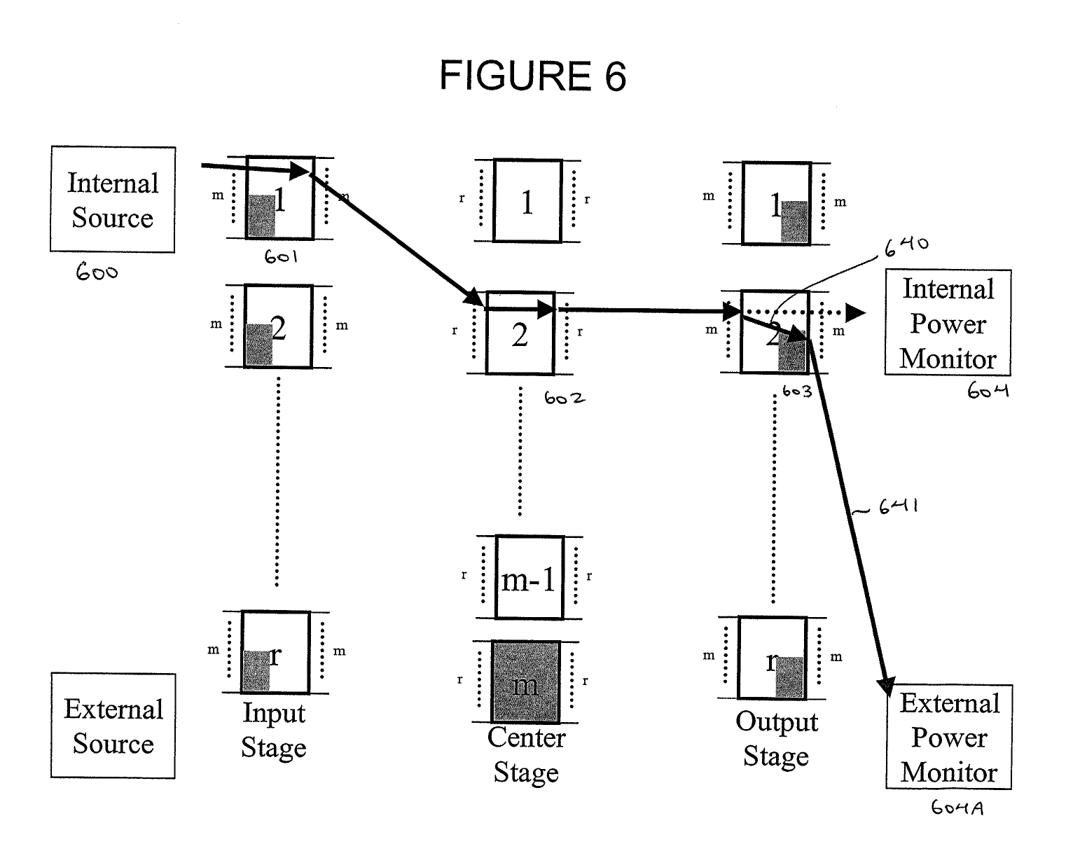

This test, depicted in FIG. 6, determines whether the final stage module is faulty. The test is the inverse of Test No. 1. All switch connections are reverted to the original ones except that the output port of the third-stage switch module 603 is changed from the original output port to the extra port that is connected to the y×1 switch, or alternatively, selector. The reported power level is observed at the external power monitor 604A. If the received power matches the expected value, the third stage module is performing properly; otherwise the third-stage switch module is the cause of the fault in the cross connect path selection.

Test No. 3:

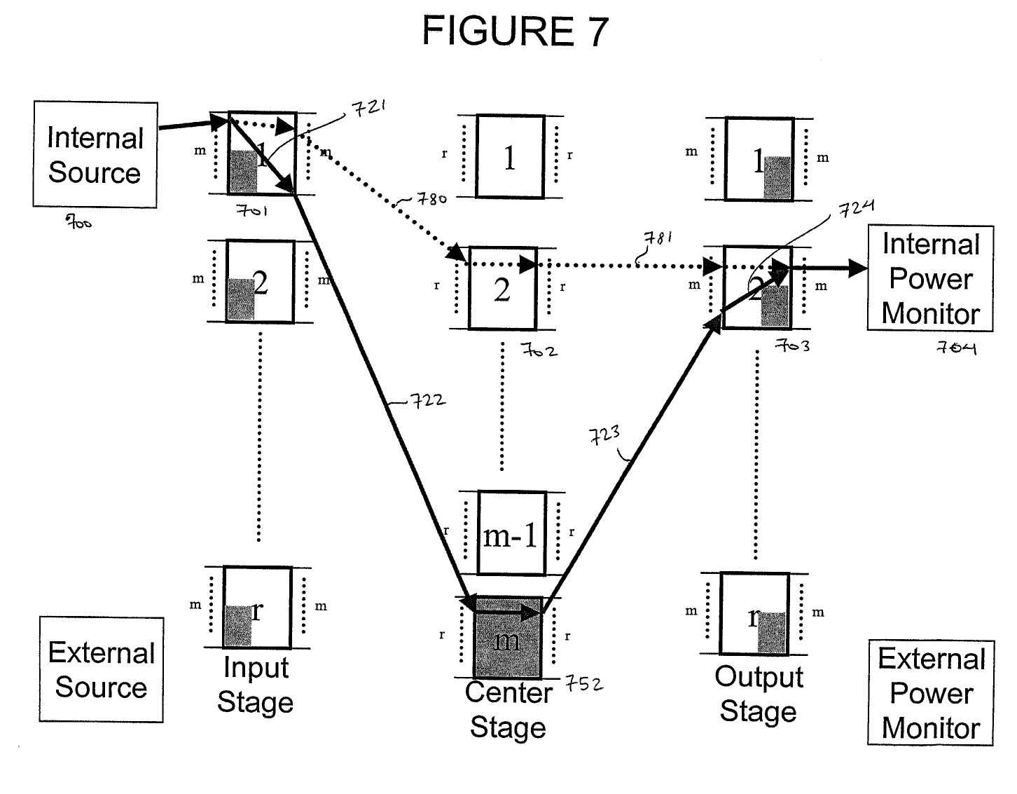

If Tests Nos. 1 and 2 did not result in isolating the fault, this test is implemented to determine if the middle-stage switch module is the cause of the fault. First the switch architecture is reverted to the original connections. Then, with reference to FIG. 7, the impacted cross-connect path is routed through the extra switch module in the middle stage 752. This bypasses completely the original middle stage switch module 702. This is achieved by switching to the extra output port in the first-stage and to the extra input port in the third-stage. This effectively routes the path selection through the extra switch module 752 in the middle stage, via path segments 721, 722, 723 and 724. If the internally reported LOP condition abates, the middle-stage switch module 702 and/or cabling segments 780, 781 are the cause of the fault.

If there are numerous middle stages, Test No. 3 is performed on each middle stage until the faulty switch module is located. I.e., the path selection through each middle stage is rerouted through its respective extra switch module, all other connections being the same as the original connections, until the middle stage with the faulty module is detected.

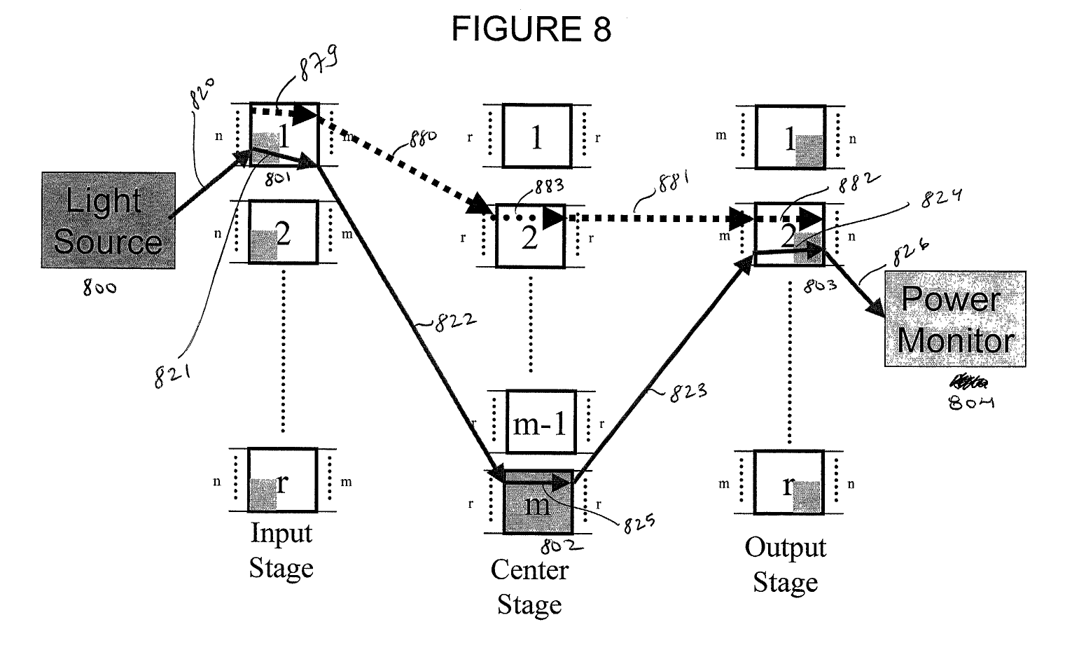

An additional test, depicted in FIG. 8 and described below, may be implemented for completeness. This additions test provides additional information, inasmuch as it alone completely bypasses the original path selection of the first and final stages. Thus if the LOP did not abate during tests 1 or 2, but abates during test 4, only a portion of the faulty switch module is impacted. I.e., the output port, or the original path from input to output ports, of the first stage switch module, or the input port, or the original path from input to output ports, of the final stage switch module, is the source of the fault. This information can be used for specific tracking of equipment failures in general, or may be used to repair such switch modules. As well, it may be desirable to temporarily route traffic through the bypassed route, if it is difficult or disadvantageous to remove the faulty switch module. Thus, knowing that a parallel route exists through such faulty switch module notwithstanding the fault, is desired.

Test No. 4:

First the switch architecture is reverted to the original connections. Then, the impacted cross-connect path is routed through the extra input and output ports of the impacted first stage switch module 801. Thus, lightpath 801 is used, completely bypassing the original first stage lightpath 879. Then, as in Test No. 3, the original middle stage lightpath through segments 880, 883, and 881 is wholly bypassed by rerouting through the extra middle stage switch module 802, using segments 822, 825 and 823. Finally, the third-stage switch module 803 is wholly bypassed from the original path 882 to a test path 824 using the extra input and output ports. The reported power level is observed at the power monitor 804. If the received power matches the expected value, then only a portion of the impacted first or final stage switch module is faulty, an an alternate path for the impacted traffic is available.

The fault isolation method described above is thus capable of isolating the fault to a unique switch module and associated cable.

The fault isolation tests described above can be either done with an external light source and external power monitor, such as is depicted in FIGS. 5-7, or they can be accomplished via an internal light source and internal receiver which is used as a source of fault isolation Tx and Rx signals. Fault isolation according to the method of the present invention is non-intrusive, and does not impact existing transmission. It can be automated as well, simply by programming the various tests described above in the event an LOP is received and the impacted ports identified, as described above.

While the above describes the preferred embodiments of the invention, various modifications or additions will be apparent to those of skill in the art. Such modifications and additions are intended to be covered by the following claims.

What is claimed:

1. An n×m switch module for use in the first stage of an N×N multi-stage optical switching architecture, comprising:
sufficient input and output ports to satisfy the Clos nonblocking criteria;
at least one extra input port;
at least one extra output port;
where the extra input and output ports are unallocated.

2. An n×m switch module for use in the final stage of an N×N multistage optical switching architecture, comprising:
sufficient input and output ports to satisfy the Clos nonblocking criteria;
at least one extra input port;
at least one extra output port;
where the extra input and output ports are unallocated.

3. The switch module of claim 1, where further additional spare ports are added such that n=m.

4. The switch module of claim 2, where further additional spare ports are added such that n=m.

5. A multi-stage optical switching architecture, comprising:
an input stage;
at least one middle stage;
and an output stage,
where the first stage comprises a plurality of the switch modules of either of claim 1 or 3; and
the second stage comprises a plurality of the switch modules of either of claim 2 or 4.

6. The architecture of claim 5, where the middle stage comprises 2n−1 m×m switch modules which are allocated; and
one m×m switch module which is unallocated.

7. The architecture of claim 6, further comprising a 1×y switch or splitter, each of whose outputs are connected to a spare port in each of the first stage switch modules.

8. The architecture of claim 6, where the input of the 1×y switch or splitter is connected to an external light source.

9. The architecture of either of claims 6-8, further comprising a y×1 switch or selector, each of whose inputs are connected to a spare port in each of the final stage switch modules.

10. A method of fault isolation for a nonblocking multistage optical switching architecture, comprising:
(a) obtaining the switch modules and ports thereof impacted in the fault;
(b) reconnecting the switching architecture at a given stage so as to bypass at least one of the input and output ports of the impacted switch module in that stage;
(c) keeping all other connections as originally configured;
(d) determining if the fault has abated; and
(e) repeating steps (b) through (d) at least once for each stage in the switching architecture.

11. The method of claim 10, where the switching architecture is reconnected such that the input port of the impacted switch module is bypassed in the input stage.

12. The method of claim 10, where the switching architecture is reconnected such that the output port of the impacted switch module is bypassed in the final stage.

13. The method of claim 10, where the switching architecture is reconnected such that both the input and output ports of the impacted switch module are bypassed in each middle stage.

14. The method of claim 10, where the switching architecture is reconnected such that in each stage, both the input and output ports of the impacted switch module are bypassed.

15. The method of any of claims 10-14, where whether the fault has abated is determined by measuring the signal power through the reconnected path.

16. The method of claim 15, where the signal power is measured via at least one of an external or an internal power monitor.

17. The method of claim 10 or 11, where when the input port of the impacted first stage switch module is bypassed, at least one of an external signal source or a dedicated fault isolation transmitter is utilized.

18. The method of claim 17, where the external signal source is arranged such that its output power is equivalent to the nominal input power of the cross-connect.

19. The architecture of claim 9, where the output of the y x 1 switch or selector is connected to at least one of an external power monitor or a dedicated fault isolation receiver.

20. An article of manufacture comprising a computer-readable medium having stored thereon instructions adapted to be executed by a processor, the instructions which, when executed, cause the processor to manage fault isolation for a nonblocking multistage optical switching architecture, comprising:
(a) obtaining the switch modules and ports thereof impacted in the fault;
(d) reconnecting the switching architecture at a given stage so as to bypass at least one of the input and output ports of the impacted switch module in that stage;
(e) keeping all other connections as originally configured;
(d) determining if the fault has abated; and
(e) repeating (b) through (d) at least once for each stage in the switching architecture.

21. The article of claim 20, where the article is integrated with the nonblocking multistage optical switching architecture.

22. The article of claim 21, where the article is further integrated with a built in fault isolation light source and power monitor.

23. The article of claim 20, wherein the instructions when executed further cause the switching architecture to be reconnected such that the input port of the impacted switch module is bypassed in the input stage.

24. The article of claim 23, wherein the instructions when executed further cause the switching architecture to be reconnected such that the output port of the impacted switch module is bypassed in the final stage.

25. The article of claim 24, wherein when the instructions are executed further causes further cause the switching architecture to be reconnected such that both the input and output ports of the impacted switch module are bypassed in each middle stage.

26. The article of claim 25, wherein when the instructions are executed further causes the switching architecture to be reconnected such that in each stage, both the input and output ports of the impacted switch module are bypassed.

27. The article of any of claims 23-26 wherein when the instructions are executed further causes the determination of whether the fault has abated to be effected by measuring the signal power through the reconnected path.
